(19) United States
(12) Patent Application Publication
(10) Pub. No.: US 2006/0268149 A1
(43) Pub. Date: Nov. 30, 2006

(54) METHOD FOR ADJUSTING EXPOSURE OF A DIGITAL IMAGE

(76) Inventor: I-Chen Teng, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/420,011

(22) Filed: May 24, 2006

(30) Foreign Application Priority Data
May 25, 2005 (TW) 094117033

(51) Int. Cl. H04N 5/235

(52) U.S. Cl. 348/362

(57) ABSTRACT

A image processing method includes selecting a high-brightness area, medium-brightness area and low-brightness area of a digital image, adjusting the brightness of the high-brightness area and low-brightness area, and adjusting the contrast of the medium-brightness area, thereby fixing the exposure of the digital image, and the digital image becomes more natural.

### BACKGROUND OF THE INVENTION

1. Field of the Invention

The present invention relates to a method for adjusting a digital image, and more particularly, to a method for adjusting exposure of a digital image.

2. Description of the Prior Art

As the information industry grows rapidly, digital products, such as digital cameras, become more popular than analog products. A traditional analog camera uses film to record an image chemically, and the recorded image must be revealed by development and other complex procedures. In addition, if a user wants to take a picture with some special effect, the user must carefully control the diaphragm, shutter, and even use a filter or apply some special technique during development, which is inconvenient to a user not familiar with the analog camera. Different from the analog camera, a digital camera records and transforms an image into digital data, and stores the digital data in a memory unit in a graphic format. The digital camera is capable of being electrically connected to a computer for storing the digital images into a hard drive, showing the digital images on a monitor, and printing the digital images by a printer, and therefore the user can view pictures immediately. Furthermore, the user can easily use image processing software to add special effects to the recorded digital image.

An image of an object will be affected as the light projected on the object changes. Generally human eyes will adapt to the change, but a sensor of the digital camera, such as a charge-coupled device (CCD), is unable to do such things. Therefore, sometimes a digital image taken by a digital camera loses some details due to over exposure or insufficient exposure. Although a user still can use image processing software to adjust an exposure of each area of the digital image, if the user is not familiar with the complex operation of the image processing software, the adjusted digital image will become unnatural. Moreover, a digital image having high resolution needs larger memory space to be adjusted, and this slows down the computing speed of a computer.

### SUMMARY OF THE INVENTION

It is therefore an objective of the claimed invention to provide a method for adjusting exposure of a digital image in order to solve the problems of the prior art.

The present invention provides a method for adjusting exposure of a digital image that includes selecting an area of the digital image according to a brightness distribution of the digital image, and adjusting an image property of the selected area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing the pre-processing of the present invention adjusting an exposure of a digital image.

FIG. 2 is a diagram showing the operation of equation (1) of the present invention.

FIG. 3 is a diagram showing the post-processing of the present invention adjusting an exposure of the digital image.

FIG. 4 is a flow chart showing the method of the present invention.

### DETAILED DESCRIPTION

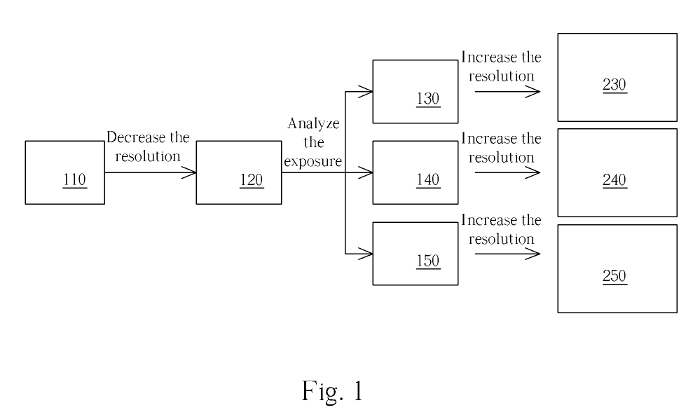

The method of the present invention can be divided into two parts: pre-processing and post-processing. Pre-processing analyzes an exposure of each area of a digital image, and post-processing adjusts the exposure of each area of the digital image and performs following procedures for making the adjusted digital image appear more natural. Please refer to FIG. 1, which shows the pre-processing of the present invention adjusting an exposure of a digital image. After receiving a digital image 110, the present invention decreases a resolution of the digital image 110 to generate a low-resolution digital image 120 in order to save memory space. Because a digital image consists of a plurality of pixels, and each pixel's property corresponds to a gray level value, the digital image can be considered as a matrix of numbers. Therefore, the digital image 110 and the low-resolution digital image 120 can be represented as a large matrix Orglmg and a small matrix Prelmg respectively. Before analyzing an exposure of each area of the low-resolution digital image 120, the pre-processing first blurs the low-resolution digital image 120 for preventing some single pixel or some specific small area from being seen as abnormally exposed due to it being much brighter or dimmer than a neighboring area. A general easy way to blur the low-resolution digital image 120 is to average gray level values of a pixel and its neighbor pixels. For example, gray level values of a pixel P and its eight neighboring pixels (a 3×3 gray level value matrix) can be averaged to be a new gray level value of the pixel P. The present invention can even average gray level values of the pixel P and its twenty four neighboring pixels (a 5×5 gray level value matrix) to be a new gray level value of the pixel P.

After blurring the low-resolution digital image 120, a high-brightness value ThrH and a low-brightness value ThrL are chosen for analyzing an exposure of each area of the blurred low-resolution digital image 120, both the high-brightness value ThrH and the low-brightness value ThrL can be user-determined values, fixed values, or auto-detected values. Generally, a digital image comprises a red channel, a blue channel, and a green channel, and each pixel of the digital image has a gray level value at each of the red, blue, and green channels. Each of the gray level values corresponds to a property of the pixel. The high-brightness value ThrH is applied to each pixel of the blurred low-resolution digital image 120. If all the gray level values of a pixel in the red, blue, and green channels are higher than the high-brightness value ThrH, that means the pixel is a high-brightness pixel, and is marked as 1, which represents that the pixel is over exposed. The other pixels are marked as 0, such that after collecting all the information (0s and 1s) of each pixel, the present invention can generate a high-brightness-pixel distribution diagram 130, which is equal to a matrix H comprising 0s and 1s. On the other hand, if all the gray level values of a pixel in the red, blue, and green channels are lower than the high-brightness value ThrH, the pixel is a low-brightness pixel, and is marked as 1, which represents the pixel has insufficient exposure. The other pixels are marked as 0, such that after collecting all the information (0s and 1s) of each pixel, the present invention can generate a low-brightness-pixel distribution diagram 140, which is equal to a matrix L comprising 0s and 1s. In addition, for analyzing the distribution of the medium-brightness pixels, the present invention turns the blurred low-resolution digital image 120 into a gray image, and applies the high-brightness value ThrH and low-brightness value ThrL to each pixel of the blurred low-resolution digital image 120. If a gray level value of a pixel is lower than the high-brightness value ThrH, and higher or equal to the low-brightness value ThrL, the pixel is a medium-brightness pixel, and is marked as 1. The other pixels are marked as 0, such that after collecting all the information (0s and 1s) of each pixel, the present invention can generate a medium-brightness-pixel distribution diagram 150, which is equal to a matrix M comprising 0s and 1s. After generating the high, low, and medium brightness-pixel distribution diagrams 130, 140, 150, the above three diagrams 130, 140, 150 can also be blurred according to the above method.

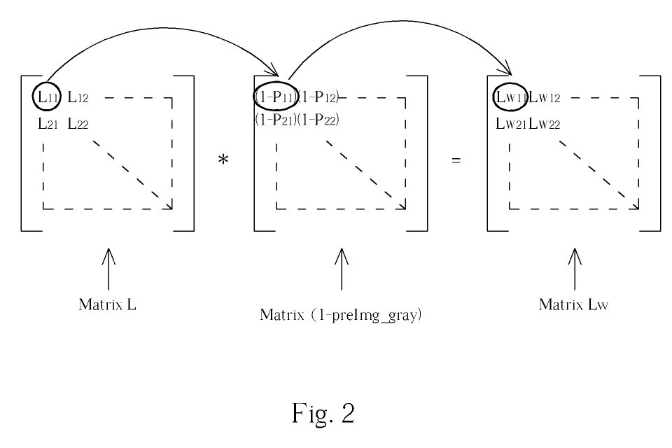

The matrix H (high-brightness-pixel distribution diagram 130) and the matrix L (low-brightness-pixel distribution diagram 140) will be multiplied by a weight value respectively and become new matrixes Hw and Lw. The equations are shown bellow:
Lw=L*(1−Prelmg_gray) (1)
Hw=H*(Prelmg_gray) (2)

Wherein “Prelmg_gray” represents the matrix of the gray level value of the blurred low-resolution digital image 120. Please refer to FIG. 2, where the operation of equation (1) is illustrated. As shown in FIG. 2, the pixels of matrix L comprise information (0s and 1s) of the low-brightness pixel distribution diagram 140, and each pixel of the matrix (1−Prelmg_grey) is equal to 1 minus each gray level value of the blurred low-resolution digital image 120, such as (1−P₁₁). A pixel of matrix Lw is equal to a pixel of matrix L multiplied by a pixel of matrix (1−Prelmg_gray), such as Lw₁₁ is equal to L₁₁×(1−P₁₁), Lw₂₁ is equal to L₂₁×(1−P₂₁), and so forth. The operation of equation (2) and the following equations are similar to the operation of equation (1) shown in FIG. 2. Thereafter, the resolutions of matrixes Hw, Lw, M are recovered to the original values, that is shown in FIG. 1 where the resolutions of the high, low, medium-brightness pixel distribution diagrams 130, 140, 150 are increased and become new high, low, medium brightness-pixel distribution diagrams 230, 240, 250 respectively. The three new diagrams 230, 240, 250 also have three new corresponding matrixes Hw′, Lw′, M′, wherein matrixes Hw′, Lw′, M′ are generated by expanding matrixes Hw, Lw, M, and filling numbers in the newly added pixels by interpolation or other algorithm.

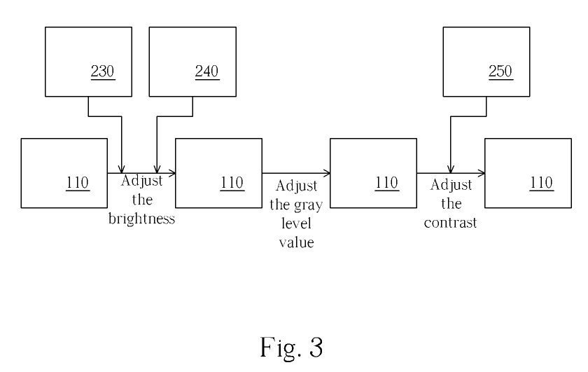

Please refer to FIG. 3, which shows the post-processing of the present invention adjusting the exposure of the digital image 110. As shown in FIG. 3, the gray level value of the pixel corresponding to the new high-brightness-pixel distribution diagrams 230 will be decreased. The equation is shown below:
HD=Orglmg*(1−Hw′)+{[max(0,(Orglmg−HlowerB))]/(1−HlowerB)}*Hw′ (3)

Wherein HD represents a new matrix of the digital image 110 after being dimmed partially, “max(0,(Orglmg−HlowerB)” means selecting a larger value between 0 and (Orglmg−HlowerB), and HlowerB could be a fixed value or a user-determined value. Because each high-brightness pixel of the new high-brightness pixel distribution diagram 230 is equal to 1 multiplied by a weight value, and other pixels are equal to 0, only the gray level value of the high-brightness pixel will be decreased.

Similarly, the gray level value of the pixel corresponding to the new low-brightness-pixel distribution diagrams 240 will be increased. The equation is shown below:
LD=HD*(1−Lw′)+HD^{1/g}*Lw′ (4)

wherein LD represents a new matrix of the digital image 110 after the brightness partially enhanced, and “g” could be a fixed value or a user-determined value. Because each low-brightness pixel of the new low-brightness-pixel distribution diagram 240 is equal to 1 multiplied by a weight value, and other pixels are equal to 0, only the gray level value of the low-brightness pixel will be increased.

After adjusting the brightness of the digital image 110, the method of the present invention further fine tunes the gray level values of the digital image 110 for making the color of digital image 110 more natural and saturated, thereby generating a new matrix LD′. Then, a contrast of each pixel corresponding to the new medium-brightness pixel distribution diagram 250 will be adjusted. The equation is shown below:
lmg=LD′*(1−M′)+contrast(LD′)*M′ (5)

wherein “lmg” represents a new matrix of the digital image 110 after having the contrast level partially adjusted, and “contrast” in equation (5) means an operation of adjusting the contrast level. Because each medium-brightness pixel of the new medium-brightness-pixel distribution diagrams 250 is equal to 1, and other pixels are equal to 0, only the gray level value of the medium-brightness pixel will be adjusted.

After the above image processing, not only has exposure of the digital image 110 been adjusted, but also the color and contrast of the digital image 110 become more natural. Besides, the above equations are general image processing equations for explaining the method of the present invention, and other similar equations with same purposes also can be applied to the present invention.

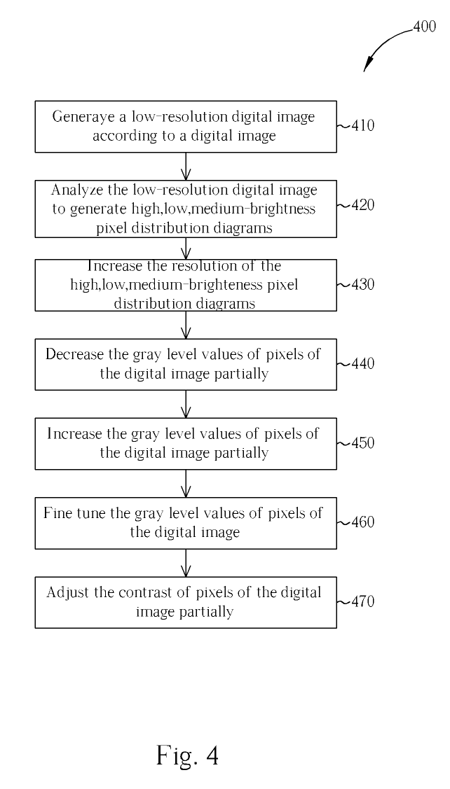

For illustrating the method of adjusting exposure of the digital image 110 more clearly, FIG. 4 provides a flowchart 400 of the method of the present invention. Please refer to FIG. 4, and refer to FIG. 1 and FIG. 3 as well; the flowchart 400 of FIG. 4 comprises the following steps:

Step 410: Decrease a resolution of a digital image 110 to generate a low-resolution digital image 120;

Step 420: Analyze the low-resolution digital image 120 to generate a high-brightness pixel distribution diagram 130, a low-brightness pixel distribution diagram 140, and a medium-brightness pixel distribution diagram 150;

Step 430: Increase the resolution of the high-brightness pixel distribution diagram 130, the low-brightness pixel distribution diagram 140, and the medium-brightness pixel distribution diagram 150 to the original resolution of the digital image 110 to generate a new high-brightness pixel distribution diagram 230, a new low-brightness pixel distribution diagram 240, and a new medium-brightness pixel distribution diagram 250;

Step 440: Decrease the gray level values of pixels of the digital image 110 according to the new high-brightness pixel distribution diagram 230;

Step 450: Increase the gray level values of pixels of the digital image 110 according to the new low-brightness pixel distribution diagram 240;

Step 460: Fine tune the gray level values of pixels of the digital image 110 to make the color of the digital image 110 more saturated;

Step 470: Adjust the contrast of pixels of the digital image 110 according to the new medium-brightness pixel distribution diagram 250.

Basically, to achieve the same result, the steps of the flowchart 400 need not be in the exact order shown and need not be contiguous, that is, other steps can be intermediate. In addition, the present invention also can directly analyze and adjust properties of the digital image 110 without generating the low-resolution digital image 120. The method of the present invention can be performed by software, hardware, firmware, or any combination of the above.

In contrast to the prior art, the present invention provides an image processing method for adjusting the exposure of the digital image 110, and making the digital image 110 more natural. The present can also generate the low-resolution digital image 120 for saving the memory space and increasing the speed of image processing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting exposure of a digital image, the method comprising the following steps:
(a) selecting an area of a digital image according to a brightness distribution of the digital image; and
(b) adjusting an image property of the selected area.

2. The method of claim 1 wherein step (a) comprises selecting a high-brightness area of a digital image according to the brightness distribution of the digital image.

3. The method of claim 1 wherein step (a) comprises selecting a low-brightness area of a digital image according to the brightness distribution of the digital image.

4. The method of claim 1 wherein step (a) comprises selecting a medium-brightness area of a digital image according to the brightness distribution of the digital image.

5. The method of claim 1 wherein step (b) comprises increasing a brightness of the selected area.

6. The method of claim 1 wherein step (b) comprises decreasing a brightness of the selected area.

7. The method of claim 1 wherein step (b) comprises adjusting a contrast of the selected area.

8. The method of claim 1 further comprising decreasing a resolution of the digital image to generate a low-resolution digital image, wherein step (a) comprises selecting the area of the digital image according to the brightness distribution of the low-resolution digital image.

9. The method of claim 8 further comprising blurring the low-resolution digital image to generate a blurred low-resolution digital image, wherein step (a) comprises selecting the area of the digital image according to the brightness distribution of the blurred low-resolution digital image.

10. The method of claim 1 further comprising blurring the digital image to generate a blurred digital image, wherein step (a) comprises selecting the area of the digital image according to the brightness distribution of the blurred digital image.

11. The method of claim 1 further comprising, after step (b), adjusting a gray level of pixels of the digital image.
